(19) United States
(12) Patent Application Publication
(10) Pub. No.: US 2007/0297122 A1
(43) Pub. Date: Dec. 27, 2007

(54) Mounting Arrangement for the Starting System of a Compressor

(75) Inventors: Oscar Colonetti, Joinville - Sc (BR); Jose Feuser Filho, Joinville - Sc (BR)

Correspondence Address: DARBY & DARBY P.C., P.O. BOX 770, Church Street Station, New York, NY, 10008-0770, US

(73) Assignee: WHIRLPOOL S.A., Sao Paulo - SP (BR)

(21) Appl. No.: 11/720,036

(22) PCT Filed: Nov. 23, 2005
(86) PCT No.: PCT/BR05/00240

§ 371 Date: Jul. 3, 2007

(30) Foreign Application Priority Data
Dec. 3, 2004 (BR) PI0405472-5

(51) Int. Cl. H02B 1/00

(52) U.S. Cl. 361/600

(57) ABSTRACT

A mounting arrangement for the starting system of a compressor of the type which comprises a shell carrying, externally: energization pins; and a starting module having an electrically non-conductive basic body fitted to said energization pins, said arrangement comprising a lock means carried by one of the parts of shell and basic body and which is elastically deformable between a locking position and a releasing position; and a lock receiving means carried by the other of said parts, said lock means being removably engaged to the lock receiving means upon the mounting of the basic body to said energization pins, in order to lock said parts against displacements that might provoke disconnection of the basic body in relation to energization pins.

### FIELD OF THE INVENTION

The present invention refers to a mounting arrangement for the starting system of the type used in electric motors, particularly single-phase induction motors for refrigeration compressors.

### BACKGROUND OF THE INVENTION

Single-phase induction motors are widely used, due to their simplicity, strength and high performance. They are employed in household appliances in general, such as refrigerators, freezers, air conditioners, hermetic compressors, laundry machines, pumps, fans and in some industrial applications.

The known induction motors are generally provided with a cage type rotor and a coiled stator having two windings, one being the run winding and the other the start winding.

During normal operation of the compressor, the run winding is supplied by an AC voltage and the start winding is temporarily supplied at the beginning of the starting operation, creating a turning magnetic field in the air gap of the stator, which condition is necessary to accelerate the rotor and start the motor.

This turning magnetic field can be obtained by supplying the start winding with a current that is out-of-time phase in relation to the current circulating in the run or main winding, preferably at an angle close to 90 degrees. This out-of-time relationship between the current circulating in both windings is obtained by constructive characteristics of the windings or by installing an external impedance in series with one of the windings, but generally in series with the start winding. This value of the current circulating through the start winding during the starting process of the motor is high, requiring the use of some type of switch which can interrupt this current after the time required to promote motor acceleration has elapsed.

For the motors in which a high torque is required during the starting period, a capacitor known as starting capacitor is connected in series with the start winding.

Other known component that forms the starting and protective modules of the electric motor is the thermal protector which has the function of protecting the electric motor in overload or short-circuit conditions. Such component, as described in known patent documents, can be mounted directly to an energizing pin of the compressor, or lodged close thereto and connected to said compressor by means of electric conductors, or even installed in the interior of said compressor in contact, for example, with the windings of the electric motor.

In the known constructions, the capacitor is usually provided away from the starting system module, but electrically connected to the latter through cables and terminals, such as in patent application WO02/47236.

In some known constructions, the starting system comprises a module, lodging, therewithin, a starting system and a motor protector and carrying, externally, at least one capacitor, the running capacitor, which is secured to said module through a capacitor support (U.S. Pat. No. 2,140,707) or directly to said module (U.S. Pat. No. 5,729,416).

While some known solutions for a module starting system can simplify the assembly of the starting and protecting elements of the compressor electric motor and also of the capacitor, such known systems have the disadvantage of not being sufficiently securely mounted to the compressor shell of the starting system, i.e., they do not avoid the involuntary removal thereof from their respective mounting position. The fragility of said assembly also occurs in relation to the capacitor which, in some constructions, is affixed through bolts directly to the refrigeration system and not to the compressor shell.

In some known constructions, after mounting the starting module to the compressor shell, it necessary to use a fixation clamp to guarantee said module will not be involuntarily detached from its connection to the energization pins projecting from the shell, during shipping of the compressor or during operation thereof, resulting from the natural vibrations in this system.

The clamp is disposed so as to surround both the starting system module and the capacitor, when the latter is mounted to the starting module, in order to guarantee the mounting condition of the module in relation to the compressor shell, i.e., fitted to the energization pins provided in said shell. This clamp presents an end portion laterally secured to the compressor shell, above the module-capacitor assembly, and another end portion secured to a lower portion of the compressor shell.

Besides requiring additional pieces, such as the clamp, to mount and guarantee the fixation of the starting module, such known solutions are deficient as to the fixation reliability, whether a capacitor is mounted or not to the starting module.

### OBJECTS OF THE INVENTION

Thus, it is an object of the present invention to provide a mounting arrangement for the starting system of a compressor which allows, with a simple construction and without using additional pieces, the starting module to be securely affixed to the energization pins of the compressor shell, guaranteeing said fixation under shipping and operational conditions of the compressor.

It is a further object of the present invention to provide a mounting arrangement, such as mentioned above, which provides the secure fixation of a capacitor to the starting module, without requiring the provision of additional fixation means, such as clamps.

It is yet a further object of the present invention to provide a mounting arrangement, such as mentioned above, which is flexible enough to allow modifying the arrangement of its components.

### SUMMARY OF THE INVENTION

The mounting arrangement for the starting system of a compressor of the present invention is applied to a compressor of the type which comprises a shell carrying, externally: energization pins; and a starting module having an electrically non-conductive basic body fitted to said energization pins. The arrangement of the present invention comprises: a lock means, carried by one of the parts of shell and basic body and which is elastically deformable between a locking position and a releasing position; and a lock receiving means carried by the other of said parts, said lock means being removably engaged to the lock receiving means upon the mounting of the basic body to said energization pins, in order to lock said parts against displacements that might provoke disconnection of the basic body from the energization pins.

Another advantageous characteristics of the mounting arrangement proposed herein will become apparent with the description of the invention given below.

### BRIEF DESCRIPTION OF THE DRAWINGS

The invention will be described below with reference being made to the enclosed drawings, by way of example of an embodiment of the invention, and in which:

FIG. 1 is an exploded perspective view of a starting module to be mounted, according to the arrangement of the present invention, to the energization pins provided in the compressor shell, without a capacitor being coupled to the basic body of said starting module;

FIG. 2 is a perspective view of the starting module illustrated in FIG. 1, but mounted to the energization pins of the compressor shell, indicating the mounting of two towers to the starting module;

FIG. 3 is a partially cut lateral view of the starting module of the present invention;

FIG. 4 is an exploded perspective view of the starting module to be mounted, according to the present invention, to the energization pins provided in the compressor shell, and showing a capacitor to be mounted to an additional support of the arrangement of the present invention and to be coupled to the basic body of the starting module;

FIG. 5 is a partially cut lateral view of the starting module of the present invention, carrying the capacitor mounted to an additional support coupled to the starting module, with the latter being mounted to the energization pins of the compressor shell;

FIG. 6 is a front perspective view of the additional support of the arrangement of the present invention, before receiving a capacitor frame and before being coupled to the starting module;

FIG. 7 is a rear view of the additional support illustrated in FIG. 6, without the capacitor;

FIG. 8 is an upper plan view of the additional support, as illustrated in FIG. 7;

FIG. 9 is a lateral view of the additional support, as illustrated in FIGS. 7 and 8; and

FIG. 10 is a lateral view of the additional support, as illustrated in FIG. 6.

### DESCRIPTION OF THE ILLUSTRATED EMBODIMENT

The present invention describes a mounting arrangement for the starting system of a compressor comprising, within a hermetic shell 1, an electric motor (not illustrated), for example a single phase induction motor, having terminals coupled to energization pins 2, generally three and projecting from the shell 1 to the exterior thereof and through which the electric motor is energized.

The assembly formed by the energization pins 2 receives and secures a starting module housing at least one of the parts of starting device and thermal protector, not illustrated. The present invention further provides a solution for the constructions in which the starting module carries a capacitor 3, for example a running capacitor of the starting system of the electric motor of the compressor.

The starting module of the present invention comprises: a basic body 10 formed in an electrically non-conductive material and housing, therewithin, a starting device and a motor protector, not illustrated, which are fitted and electrically coupled to the energization pins 2 of the shell 1 of the compressor.

In a constructive solution, the basic body 10 of the starting module receives a closure (not illustrated) covering, for example, a face of the basic body 10 that is turned to the shell 1 of the compressor.

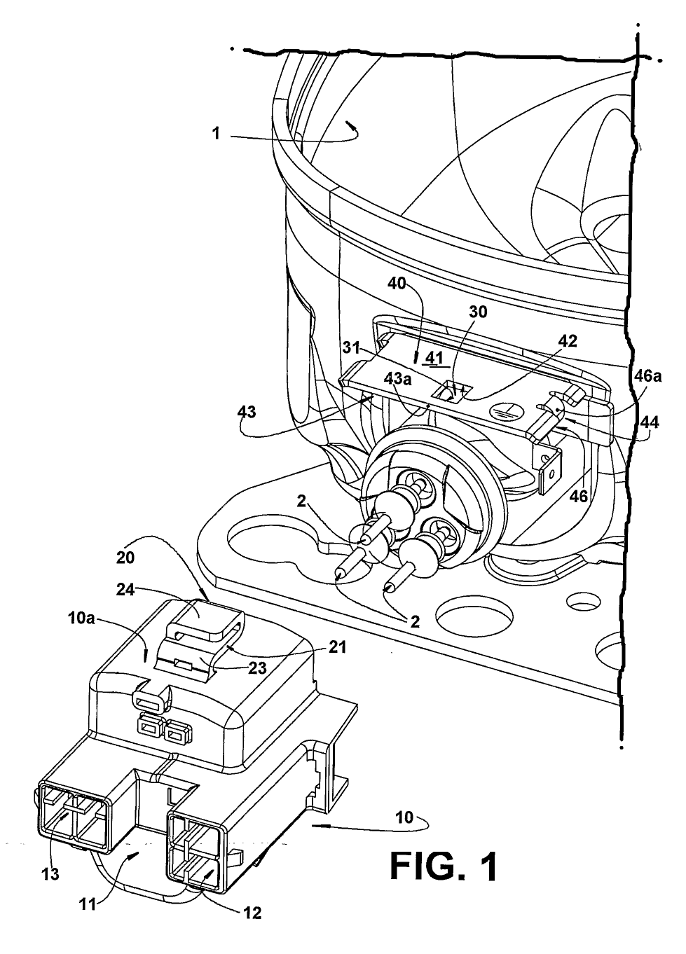

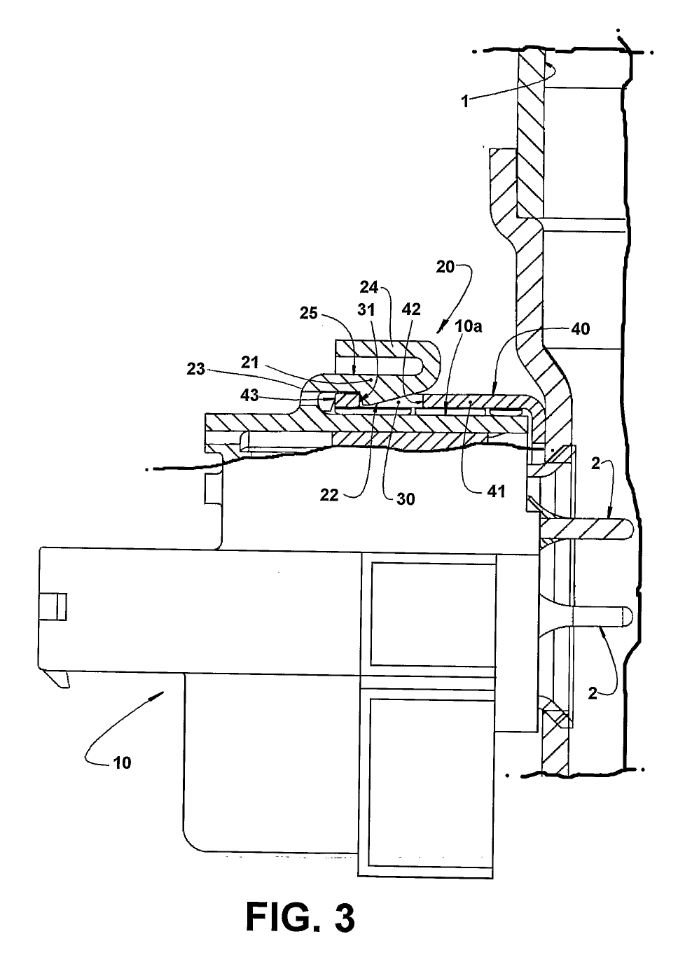

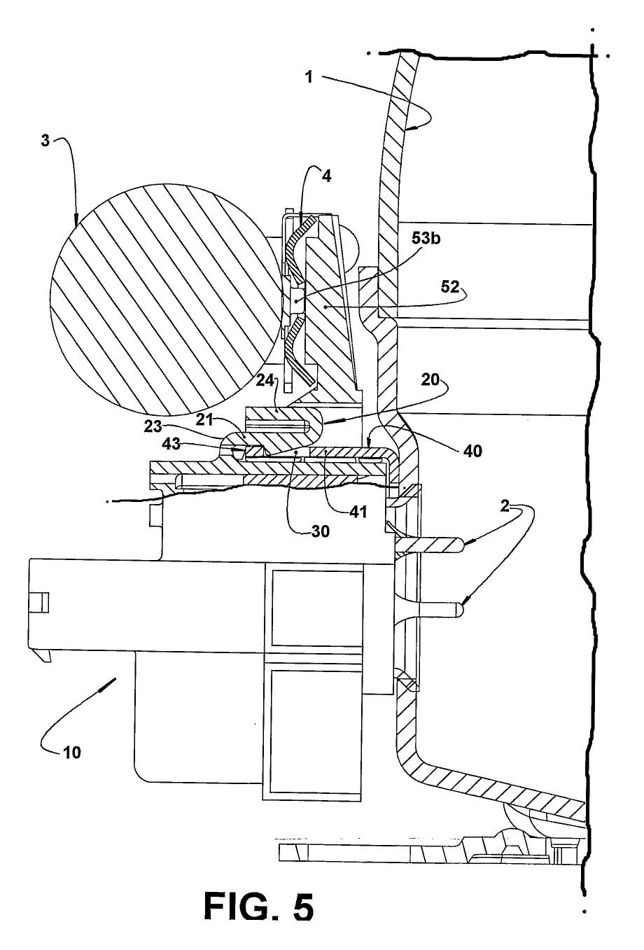

According to the constructions illustrated in FIGS. 1-5, the basic body 10 presents, incorporated to an external face 11, first openings 12 for connection to an electrical current power source, not illustrated. In the construction illustrated in FIGS. 1-5, the basic body 10 is constructed such that to allow the coupling of a capacitor, not illustrated, which coupling is achieved through adequate wiring having terminals fitted in second openings 13 provided in the basic body 10.

Each of the first and second openings 12 and 13 carries a respective terminal electrically coupled to one of the parts of starting device and thermal protector of the starting module.

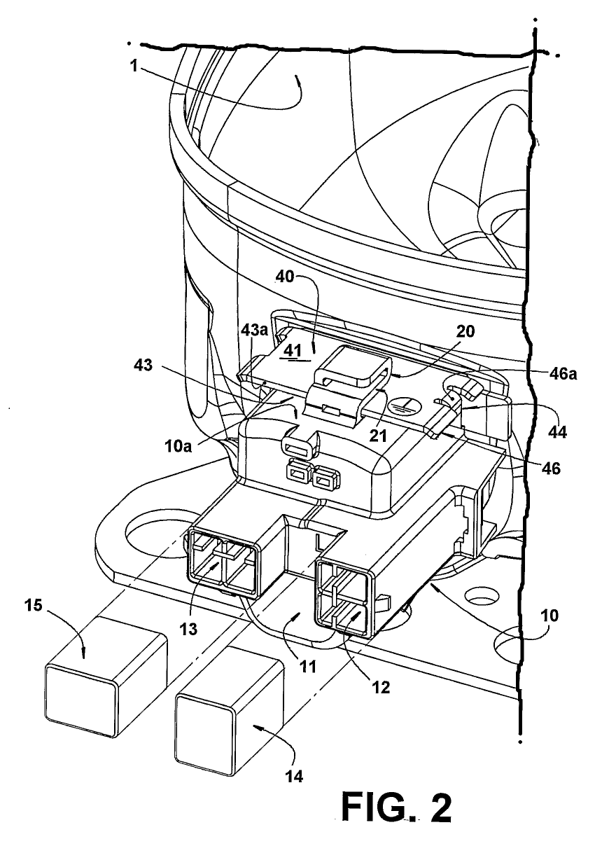

According to the illustration in FIG. 2, the starting module of the present invention may carry a first tower 14 made in an electrically insulating material and to be applied to the basic body 10 so as to be carried thereby in the region of the first openings 12, in order to allow coupling a certain energization terminal construction (not illustrated) to the latter.

The starting module constructions that couple a capacitor and in which, as illustrated, the basic body 10 is provided with second openings 13, the arrangement of the present invention provides a second tower 15, in an electrically insulating material and to be applied to the basic body 10 so as to be carried thereby in the region of the second openings 13, defining a protection for the connection of the capacitor to the starting module.

For mounting the starting module to the energization pins 2 of the compressor, the arrangement of the present invention comprises a lock means 20, carried by one of the parts of shell 1 and basic body 10 and which is elastically deformable between a locking position and a releasing position, and a lock receiving means 30 carried by the other of said parts, said lock means 20 being removably engaged to the lock receiving means 30 upon the mounting of the basic body 10 to said energization pins 2, in order to lock said parts against displacements that might cause displacement of the basic body 10 in relation to the energization pins 2.

According to the present invention, the lock means 20 comprises a tab 21 projecting, from the part that carries it, in a direction parallel to the energization pins 2 and incorporating a tooth 22 in the form of a ramp, for example. The lock receiving means 30 is provided with a stop 31 carried by the other part and against which said tooth 22 is seated in the locking position and said stop 31 is defined, for example, by one of the edges of a recess produced in the part that carries the lock receiving means 30.

In a way of carrying out the present invention, the lock receiving means 30 is provided in a support means 40, projecting from the respective part and which can be defined, for example, as a support plate 41, and the stop 31 that forms the lock receiving means 30 can be defined by a front edge of a window 42 provided in said support plate 41.

In order to lock the basic body 10 of the starting module to the energization pins 2 according to the invention, the support plate 41 is fitted with a small gap between the tab 21 of the lock means 20 and a face of the part that carries said tab 21.

In a way of carrying out the present invention, the support plate 41 is flat and the tab 21 lies parallel to the face of the part that carries it. In the illustrated construction, the support plate 41 is fitted between the tab 21 of the lock means 20 and a face of the basic body 10. It should be understood that, in the illustrated construction, said face is the upper face 10a of the basic body 10, when the support plate 41 is provided above the energization pins 2, and horizontally affixed to the shell 1, for example by welding. In this construction, the lock means 20 is carried by the basic body 10 and the tab 21 lies parallel to the upper face 10a of said basic body 20 and incorporated to said upper face 10a in a single piece, through a small projection 23.

Though not illustrated, the present invention foresees that the support plate 41 can be positioned laterally or inferiorly to the basic body 10, said positioning not interfering in securing said basic body 10 to the shell 1.

In the illustrated construction, the support plate 41 is mounted superiorly to the basic body 10, facilitating the assembly of an additional support 50 to be affixed to one of the parts of shell 1 and basic body 10 and to carry a capacitor 3 operatively coupled to the starting module. One of the parts defined by the additional support 50 and the part that carries it is provided with retaining means 55, 57, to be described below, and the other part carries stop means 43, 44 (also described below), which receive the retaining means 55, 57, locking the additional support 50 to the respective part, avoiding relative involuntary displacements when the basic body 10 is in the mounted condition in relation to the energization pins 2.

In an embodiment of the present invention, the additional support 50, for example in an elastomeric material, comprises a basic portion 51 seated against the part that carries said additional support 50 and which is provided with the retaining means 55, 57, and a column portion 52 projecting from the basic portion 51, for example orthogonal to the latter and adjacent to the shell 1, and carrying the capacitor 3.

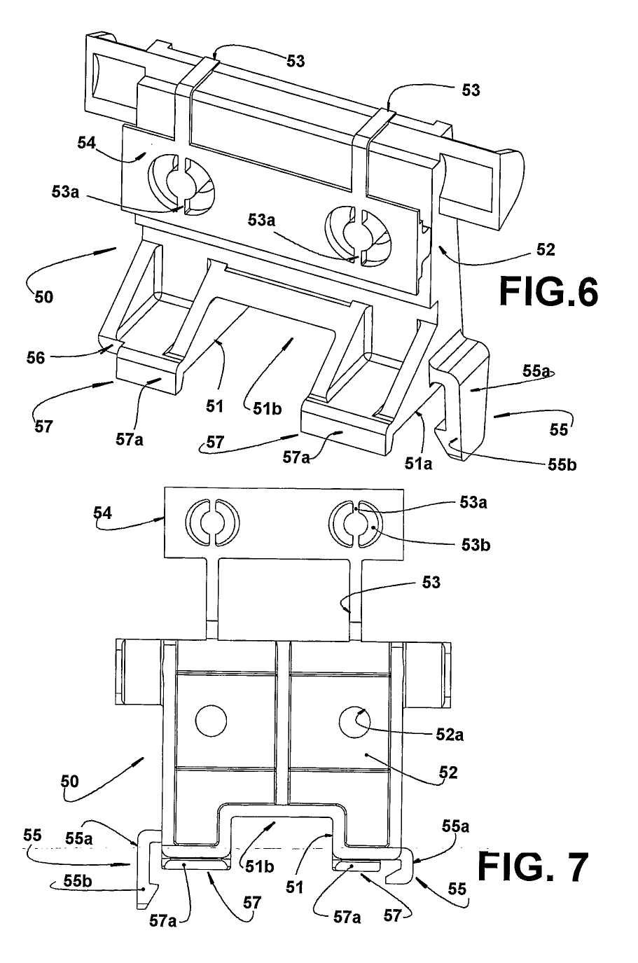

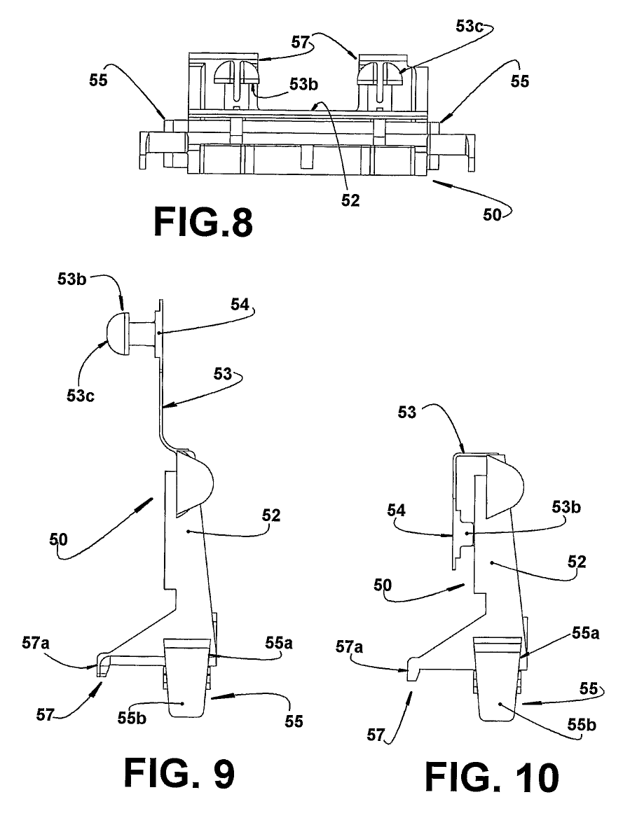

According to the illustrations in FIGS. 6-10, the basic portion 51 present a cut-out median portion 51b defining a gap to receive the lock means 20, without the latter interfering neither with the additional support 50, nor with the capacitor 3 mounted to said additional support 50.

The column portion 52 of the additional support 50 carries, superiorly, at least one mounting claw 53 which defines, in a respective end portion 53a, a corresponding lock pin 53b which is elastically deformable so as to be introduced in a corresponding through opening 52a provided in the column portion 52, as described below.

According to the illustrations of FIGS. 6-10, the column portion 52 carries two mounting straps 53 united to each other through an auxiliary plate 54 incorporating their end portions 53a. In the illustrated constructive option, the mounting straps 53, the auxiliary plate 54 and the lock pins 53b are provided in a single piece.

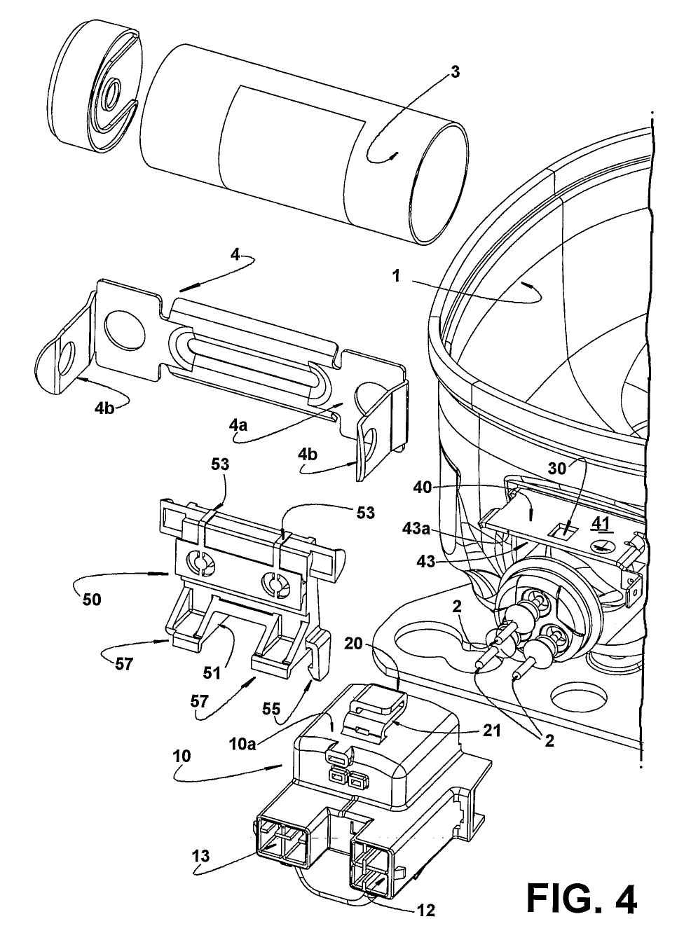

According to the present invention, the mounting straps 53 are dimensioned to surround at least part of a frame 4 of the capacitor 3, as illustrated in FIGS. 4-6, 8 and 10, seating a base portion 4a of said frame 4 against a face of the auxiliary plate 54, opposite to that face wherefrom the lock pins 53 project, retaining said frame 4 to the additional support 50. In this condition, each lock pin 53b is forced against a respective through opening 52a of the column portion 52, until a head portion 53c of each lock pin 53b projects from the respective through opening 52a and seats against an adjacent face of the column portion 52.

The illustrated frame 4 of the capacitor 3 is “U” shaped, having two retaining arms 4b, each projecting from an adjacent edge of the base portion 4a of said frame 4. The retaining arms 4b are elastically deformable to receive and retain, under pressure, a capacitor 3, through the ends thereof.

The head portion 53c of each lock pin 53b has a diameter superior to that of the respective through opening 52a, the passage through the latter being allowed due to the elastic deformation of the head portion 53c of each lock pin 53b, said head portion 53c being splitted so as to allow said elastic deformation of said head portion 53c upon passing through the through opening 52a, until a flat face of each head portion 53c is seated on the column portion 52, around a respective through opening 52a.

According to the present invention, the retaining means 55 comprise at least two retaining claws 55a, at least one of them being flexible and provided with a respective projection 55b. Each retaining claw 55a is provided from a lateral edge 51a of the basic portion 51 of the additional support 50, for example from a rear portion of each lateral edge 51a and acts against an adjacent lateral portion of the support means 40, for example each lateral portion 46 of the support plate 41.

In the illustrated construction, one of the retaining claws 55a is rigid and fits in an adjacent lateral portion 46 of the support plate 41 and the other retaining claw 55a is flexible and elastically deformable between a mounting position and a dismounting position in relation to the support plate 41.

According to the present invention, the retaining means 57 further comprise at least one retaining tab 57a provided from a front edge portion 56 of the basic portion 51 of the additional support 50, as illustrated in FIGS. 6-10 and acting against an adjacent front portion of the support means 40, for example seating against a front edge 43a of the support plate 41, which defines the respective stop means 43. Said retaining tab 57a is provided so as to define, with the retaining claws 55a provided in the lateral edges 51a of the basic portion 51 of said additional support 50, a triangular arrangement. The front edge 43a of the support plate 41 defines the respective stop means 43 which operates as a stop against the displacement of the additional support 50 in direction to the shell 1.

The triangular arrangement is designed to define a better stability for the additional support 50.

According to the present invention, at least part of the retaining claws 55a and retaining tab 57a is provided with a respective projection to be seated against a respective stop means 43, 44 provided in the support means 40 to lock the additional support 50 against the support means 40.

According to the illustrations, only one of the retaining claws 55a is provided with a projection 55b so as to retain the additional support 50 against the support plate 41.

In the constructive solution in which the support means 40 is the support plate 41, at least one of the lateral portion 46 thereof is provided with a stop means 44 to receive a respective projection of a retaining claw 57a.

In the illustrated construction, only one of the retaining claws 55a is provided with a projection 55b, retaining the additional support 50 to the support plate 41 and the other retaining claw 55a is fitted around an adjacent lateral portion 46 of the support plate 41.

The tab 21 further defines a housing to receive a tool, not illustrated, which allows dismounting the parts of the additional support 50 in relation to the basic body 10 of the starting module, since the arrangement of the present invention is provided so as to avoid the direct manual removal and dismount of the capacitor 3 in relation to the starting module.

According with the illustrations, the tool housing is defined in a gap located between the projection 24 of the tab 21 of the lock means 20 and a face 25 of the tab 21 opposite to that carrying the tooth 22, said projection 24 being spaced from and parallel and adjacent to said face 25 of the tab 21 and dimensioned to receive an end portion of a tool.

1. A mounting arrangement for the starting system of a compressor of the type which comprises a shell carrying, externally: energization pins; and a starting module having an electrically non-conductive basic body fitted to said energization pins, wherein it comprises a lock means carried by one of the parts of shell and basic body and which is elastically deformable between a locking position and a releasing position; and a lock receiving means carried by the other of said parts, said lock means being removably engaged to the lock receiving means upon the mounting of the basic body to said energization pins, in order to lock said parts against displacements that might provoke disconnection of the basic body in relation to the energization pins.

2. The mounting arrangement as set forth in claim 1, wherein the lock means comprises a tab projecting from the part that carries it, in a direction parallel to the energization pins and incorporating a tooth, and the lock receiving means is provided with a stop carried by the other part and against which said tooth is seated in the locking position.

3. The mounting arrangement as set forth in claim 2, wherein the tooth has the form of a ramp.

4. The mounting arrangement as set forth in claim 3, wherein the stop is defined by one of the edges of a recess produced in the part that carries the lock receiving means.

5. The mounting arrangement as set forth in claim 4, wherein the lock receiving means is provided in a support means projecting from the respective part.

6. The mounting arrangement as set forth in claim 5, wherein the support means is defined by a support plate and the stop of the lock receiving means is defined by a front edge of a window provided in the support plate.

7. The mounting arrangement as set forth in claim 6, wherein the support plate is fitted with a small gap between the tab of the lock means and a face of the part that carries said tab.

8. The mounting arrangement as set fourth in claim 7, wherein the support plate is flat and the tab is disposed parallel to the face of the part that carries it.

9. The mounting arrangement as set forth in claim 6, wherein the support means is provided above the energization pins.

10. The mounting arrangement as set in claim 7, wherein the support plate is horizontally affixed to the shell.

11. The mounting arrangement as set forth in claim 10, wherein the tab of the lock means is carried by the basic body of the starting module and disposed parallel to an upper face of said basic body.

12. The mounting arrangement as set forth in claim 1, wherein it comprises an additional support to be mounted to one of the parts of shell and basic body, in order to carry a capacitor operatively coupled to the starting module, and in that one of the parts defined by the support plate and the part that carries the latter is provided with retaining means and the other part carries stop means which receive the retaining means locking the additional support to the respective part against relative involuntary displacements in the mounting condition of the basic body in relation to the energization pins.

13. The mounting arrangement as set forth in claim 12, wherein the additional support comprises a basic portion seated against the part that carries said additional support and provided with the retaining means, and a column portion projecting from the basic portion and adjacent to the shell and carrying the capacitor.

14. The mounting arrangement as set forth in claim 13, wherein the column portion of the additional support is provided with at least one mounting claw which secures the capacitor to the additional support, avoiding involuntary displacements of said parts.

15. The mounting arrangement as set forth in claim 14, wherein the column portion carries two mounting straps surrounding an adjacent portion of a frame of the capacitor.

16. The mounting arrangement as set forth in claim 15, wherein each mounting claw carries a respective lock pin which is elastically deformable so as to be mounted to the column portion of the additional support, retaining the frame of the capacitor seated against an adjacent face of the column portion.

17. The mounting arrangement as set forth in claim 16, wherein the lock pins project from an auxiliary plate carried by the mounting straps.

18. The mounting arrangement as set forth in claim 17, wherein the auxiliary plate is seated against the column portion.

19. The mounting arrangement as set forth in claim 18, wherein the mounting straps, lock pins and auxiliary plate are incorporated in a single piece to the additional supports.

20. The mounting arrangement as set forth in claim 15, wherein the retaining means comprise at least two retaining claws, each provided from a lateral edge portion of the basic portion of the additional support and acting against an adjacent lateral portion of the support means.

21. The mounting arrangement as set forth in claim 20, wherein the retaining means comprise a retaining tab provided from a front edge portion of the basic portion of the additional support and operating against an adjacent front portion of the support means, said retaining tab being provided so as to define, with the retaining claws provided in the lateral edges of the basic portion of said additional support, a triangular arrangement.

22. The mounting arrangement as set forth in claim 21, the front portion of the support plate defines a stop against the displacement of the additional support in direction to the shell.

23. The mounting arrangement as set forth in claim 21, wherein at least part of the retaining claws is provided with a respective projection provided in the support means, in order to lock the additional support against said support means.

24. The mounting arrangement as set forth in claim 23, wherein the retaining claw provided with a projection is flexible and elastically deformable between a mounting position and a dismounting position in relation to the support means.

25. The mounting arrangement as set forth in claim 24, wherein the support means comprises a support plate which is provided, in each respective lateral portion, with engaging cutouts, one of them receiving a respective projection of a retaining claw.

26. The mounting arrangement as set forth in claim 25, wherein the other retaining claw fits around an adjacent lateral portion of the support plate.

27. The mounting arrangement as set forth in claim 1, the tab of the lock means carries a projection which is spaced from and parallel and adjacent to a face of the tab, opposite to that carrying the tooth.

28. The mounting arrangement as set forth in claim 1, wherein the additional support is in elastomeric material.
